(19) United States
(12) Patent Application Publication
(10) Pub. No.: US 2011/0296514 A1
(43) Pub. Date: Dec. 1, 2011

(54) METHOD FOR CREATING A PERSONALIZED INSIGNIA

(76) Inventor: Joerge KOENNECKE, Hamburg (DE)

(21) Appl. No.: 13/114,428

(22) Filed: May 24, 2011

Related U.S. Application Data
(60) Provisional application No. 61/348,302, filed on May 26, 2010.

(51) Int. Cl. G06F 15/16

(52) U.S. Cl. 726/9

(57) ABSTRACT

The invention relates to a method for verifying access of a user of an online presence to a user site or a group site at the online presence through an identifier (2) attached to a personalized insignia (1) comprising a physical object, whereby the method comprises the following steps: Reading in of an identifier code, which is carried by the identifier (2) and unique to said insignia (1), at an input device (4) of a terminal (3) located in a proximity of the insignia (1); Receiving the identifier code from the terminal (3) by an insignia server (5) of the online presence; Searching through an insignia database (6) of the insignia server (5) correlating identifier codes to user accounts and/or group accounts; Verifying that the identifier code is correlated to a certain user account and/or a certain group account of the online presence. The invention furthermore relates to a personalized insignia (1).

The invention relates to a method for linking a web presence of a user or group to an insignia in form of a physical object. As a result, the object becomes personalized and allows various uses, such as a quick link to the web presence, access and verification methods for online and “real” life activities or as a special fashion object.

Online presences are very important for people, companies and organizations around the world for expressing themselves and to obtain and exchange information. In particular, so called social networks are becoming central platforms for cultivating social contacts and taking part in cultural exchange. As such, networks are also ideal platforms for economic entities to convey their commercial messages and to advertise their products. However, neither the online presences of the people nor of the companies have a real linkage to the physical world. On the other hand, products sold in real life also provide no direct link to the various online presences.

It is already possible and very often taken advantage of, to sell goods and services online. It is also very common to exchange virtual goods in social network environments, which are then displayed on user sites on these social networks. There is, however, still missing an effective link between such activities and the physical world in order to make it more attractive for users and groups of such social networks to adapt this behavior of exchanging gift to physical objects.

It is therefore an objective of the present invention to provide a method and a product for helping to overcome this gap between online presences and the physical world activities of users of such online presences.

The object is achieved in this invention by providing a method with the features of claim 1 or 16 and a personalized insignia with the features of claim 17. Advantageous embodiments of the invention are subject of the sub-claims.

The invention is based on the concept of providing personalized objects (insignia), by creating a one to one correlation between the insignia and a user or a group site of an online presence. Herein the expression insignia stands for a physical object. Such an insignia may for example be merchandize offered by and possibly easily associated to a certain company, such as a coffee cup of Starbucks®. It may also be an object with a rather personal value, such as a friendship ring or some other fashion object for indicating that its wearer is associated with a certain group or with certain other people.

The personalization of the insignia is achieved by providing the insignia with an individual identifier code (unique identification code—UID) and creating a correlation in an insignia database between this identifier code and a user account or a group account of the online presence. An internet or web server presenting or providing the online presence on the internet will have electronic access to the insignia database directly or via a communication network. Once the identifier code belonging to the insignia is received by the internet server of the online presence, a search is started to verify that the identifier code is listed inside the insignia database and to find the user presence and/or the group presence, to which the identifier code is correlated.

Web servers in private intranets may be considered accordantly, as they may offer the same services in a smaller, private way. Additionally, the mapping and management of UID of the insignia and the user entries of the online presences may be done at an independent insignia data base or at the user databases behind the websites. In case of the latter, the insignia UID and if required an insignia PIN becomes an additional value for the user entry. In other words, the user/group account may be extended by an additional flag for the insignia and if security is required by an additional personal password (PIN) for the insignia.

The identifier code is carried by an identifier, which is physically attached or incorporated to the insignia itself. The identifier may for example be glued or otherwise fixed to an outside surface of the insignia. Alternatively it may be embedded partly or completely inside the insignia. The identifier code is unique to each insignia and identifies the attached one, in order to assure a personalization of the insignia in connection with the entry in the insignia database. In other words, at least in an insignia database used by the insignia server, the identifier codes given to the insignias are each unique to their corresponding insignia. No two insignias may carry the same identifier code.

In order to be received by the internet server, the identifier code has to be read out of the identifier. For this, the insignia is placed in proximity of a terminal comprising an input device. The identifier code is then read in by the input device. The terminal may be any electronic device capable of communicating with the internet. It may be a personal computer of a user or it may be a device placed in a shop, department store, or mall. Alternatively, the terminal may be part of a cashier system, for example in a coffee shop or the like.

The insignia may be provided by a retail store, by a vendor, by a social network provider or even by the user himself. In the latter case, the user will have to take the step of attaching to his or her chosen insignia an identifier, possibly obtained through one of the suppliers mentioned above. In addition to the linkage to social network functions conferred to the user by the insignia as described above, the insignia may be even used to allow access to the online user profile or the Internet access device itself. In this case, the recognition of the identifier code of the insignia will have to precede or accompany the logon procedure for a personal computer (PC) or concerned application. Furthermore, the insignia may be used for obtaining physical access to a building or a room, or it may be utilized for identifying a user.

In a preferred embodiment, the identifier code is carried by the identifier electronically. The identifier may for this purpose include an electronic memory, which may be read out by an electric contact connection, possibly via an electric transmission or via a direct cable.

According to an advantageous embodiment, the identifier code is read in from the identifier by the input device automatically. Examples for automated reading-in devices include an optical scanner, for example for detecting barcodes, alphanumeric codes, or other suitable codes printed on the identifier. Furthermore, the identifier may include an RFID chip which is read out by an RFID reader or transmitted to it in the case of an active RFID chip. An alternative to the automatic reading-in of the identifier code may be inputting the identifier manually into a keyboard or keypad or through audio instructions. Irrespective of whether the read-in procedure is performed automatically or the identifier code is entered manually into the input device, the identifier code may include a numeric or alphanumeric code such as a serial number for the individual insignia.

Besides the use of an RFID identifier, there might be other advantageous methods of reading in the identifier code from the identifier by the input device remotely. In the present case, remotely means that there is no physical contact between the identifier and the input device. The insignia will still have to be located in the proximity of the input device in order to enable the reading-in of the identifier code. Therefore, the meaning of proximity depends on the design of the identifier and the input device. In case of the above described remote detection, the insignia may have to be at least placed inside the same building or preferably inside the same room as the input device.

For added security, the identifier may include a cryptoprocessor to protect the unique ID and the corresponding verification process, such as a so called smartcard.

In preferred embodiments, the online presence comprises a social network. This may be a widely used commercial network such as Facebook®, LinkedIn®, Xing® or the like. Alternatively, the online presence may be an individual web presence of a user, company or organization such as Starbucks® or Greenpeace®, possibly standardized in the form provided by blog sites, by MySpace® or the like. Other online presences such as internet providers and content providers may also benefit from the use of presently described personalized insignias.

According to a preferred embodiment, the method further comprises the following steps: Sending the identifier code read in at the input device by the terminal to a vendor server; Sending the identifier code received by the vendor server to the internet insignia server; and receiving a verification message from the insignia server by the vendor server, whereby the verification message comprises a user account and/or a group account information identifying the certain user account and/or the certain group account of the online presence, to which the identifier code is correlated.

Additionally, the identifier code may be sent to a backend server hosting the insignia database. The insignia codes may be verified and managed in the insignia database. In the case, that the online presence is accompanied by a user account and/or group account, the verification message will also consist of information identifying the certain user account and/or the certain group account of the online presence, to which the identifier code is correlated.

In this embodiment, as well as the following one, the terminal to which the input device is connected may be placed far away from the vendor server and connected thereto via telecommunication means, or the terminal may be located at the same position as the vendor server, e.g. in the case of offering such services in a private environment.

In an alternative embodiment, in addition to the identifier code, a user name corresponding to the user account and/or a group name corresponding to the group account may be sent by the vendor server to the insignia server. In this case, the insignia server would need only to include in its verification message a confirmation notice that the identifier code is correlated to the particular user account and/or the particular group account of the online presence.

The verification message in any of the above described embodiments may be transmitted by http or my any other electronic communication means, preferably through a secure line.

According to a further alternative embodiment, the method comprises the following steps: Sending the identifier code, read in at the input device by the terminal, to the insignia server; and Enabling access to the user account and/or the group account by the terminal, if during the verifying step it is determined that the identifier code is correlated to that user account and/or that group account of the online presence.

In a preferred embodiment, the enabling access to the user account and/or the group account comprises a login procedure, whereby a user at the terminal logs into his user site or into a group site. The above described verifying step may thus accompany or precede a login procedure for accessing a user or group account on the social network. Alternatively, the verifying step may even replace the login procedure.

In a preferred embodiment, the method includes a step of mirroring entries of the insignia database onto the terminal to produce a mirror database for reference in cases a connection to the insignia server cannot or should not be established.

One or all of the herein described embodiments may be extended with verifying and confirming an insignia password (PIN) to secure usage of the Insignia. For example, a step of receiving a personal identification number (PIN) by the insignia server and a step of verifying that the personal PIN is associated to the identifier code in the insignia database might be added to the method. In this case, there might be furthermore added a step of sending the PIN requested by the terminal and entered by the user to a vendor server.

In a further preferred embodiment, the method is characterized by a step of registering the insignia with the online presence, wherein the identification code is received by the insignia server and inserted into the insignia database, correlating it to the user account and/or the group account. The registering step may be performed before sending the insignia to a user, or it may be performed as a first step before the user may utilize the purchased or received insignia.

In an alternative embodiment, during the step of registering the insignia, the identification code is inserted electronically into the identifier of the insignia. The insertion of the identification code into the identifier may be performed via the same input device responsible for reading in the identifier code from the identifier. In any case, a previous or default identifier code may be overwritten in this process.

Preferably, the correlation between the insignia and the user account and/or the group account will be displayed at a corresponding user site or a corresponding group site in the online presence, thereby showing to other users of the social network the connection between the user account and/or the group account and the insignia.

In an alternative method for creating a personalized insignia by linking a physical object to an online presence of a user or a group through an identifier attached to the insignia comprising the physical object, the following steps are performed: Receiving an order for the insignia; Registering the insignia with the online presence, wherein the identification code is generated or received by the insignia server and inserted into the insignia database, correlating it to the user account and/or the group account; Inserting the identification code into the identifier of the insignia; and sending the insignia to a vendor or to a user.

In a further advantageous embodiment, a user profile is built based on online and/or offline activities of the user of the personalized insignia (1), whereby for building the user profile, an analysis is performed, taking into account the usage of the insignia in correlation to the identifier, access and verification requests directed at the insignia database, and/or access to a terminal of a partnering company. Such user profiles may be utilized for targeted advertizing aimed at the user, based on his or her preferences and previously purchased goods and services.

Some examples of embodiments of the invention will be explained in more detail in the following description with reference to the accompanying drawings, wherein:

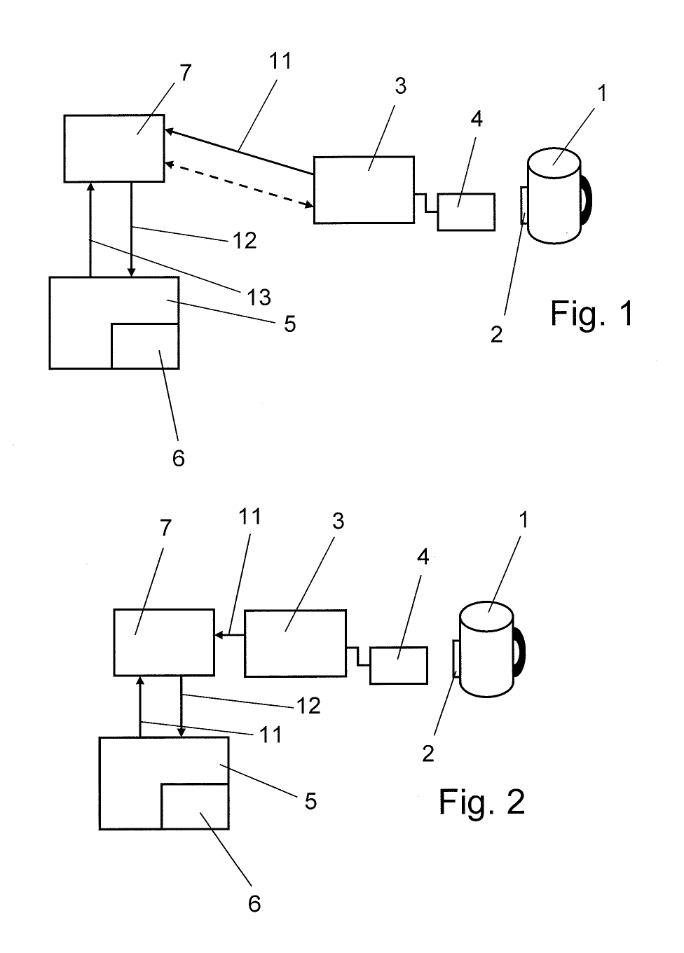

FIGS. 1 to 4 show schematic diagrams of arrangements in a network environment comprising a terminal and an insignia server in different embodiments;

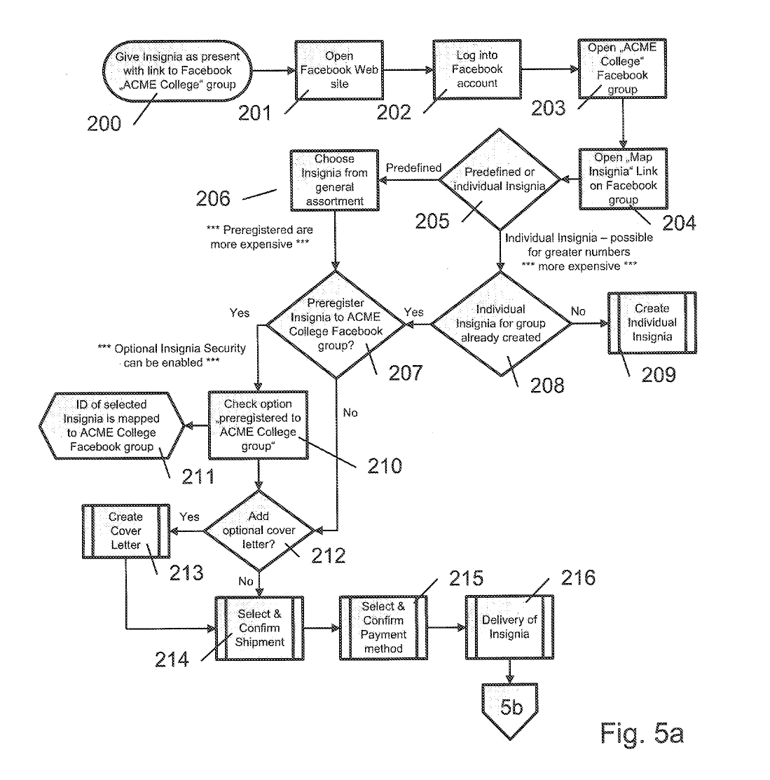

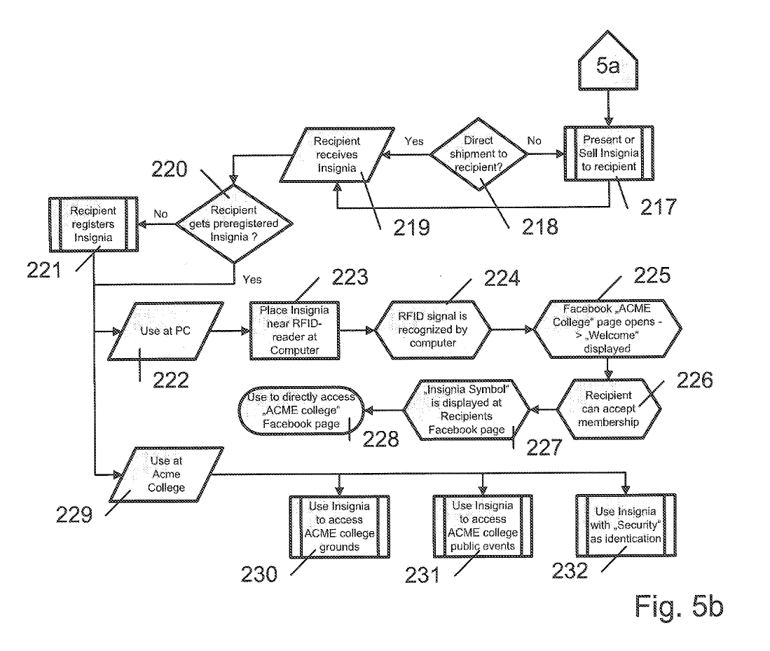

FIG. 5 illustrates a process of offering insignias as presents with a link to a vendor group site of a vendor in a social network;

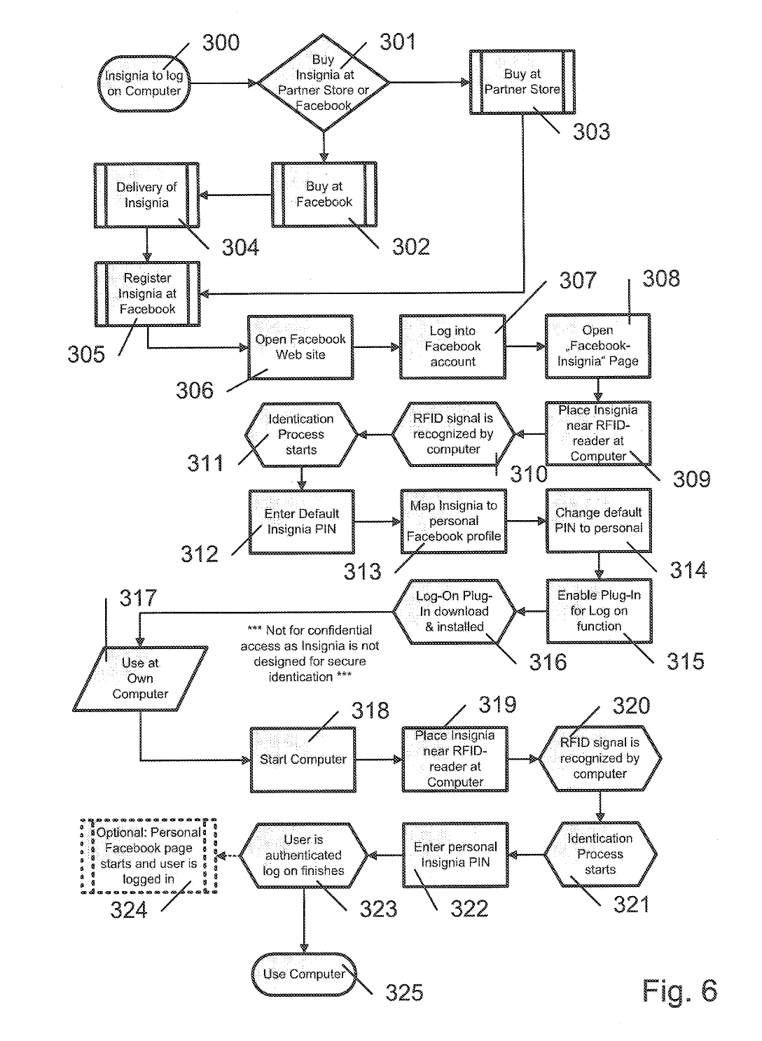

FIG. 6 shows a diagram of a process of buying an insignia and using it to log onto a computer;

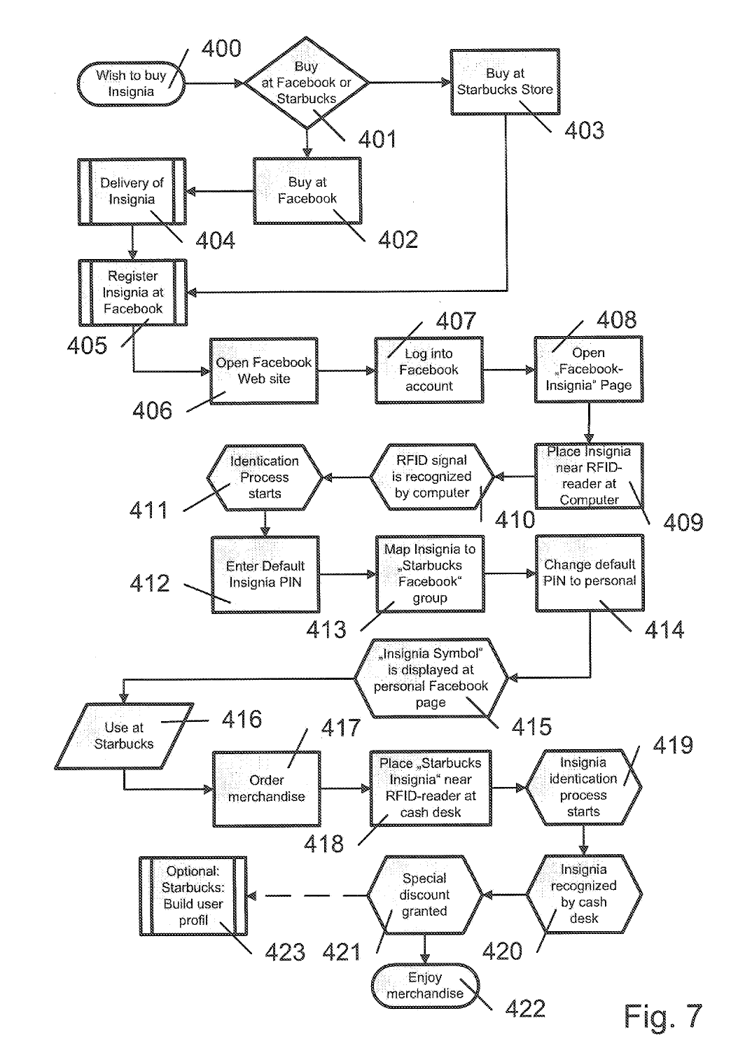

FIG. 7 shows a diagram of a process of buying an insignia and using it at a vendor store;

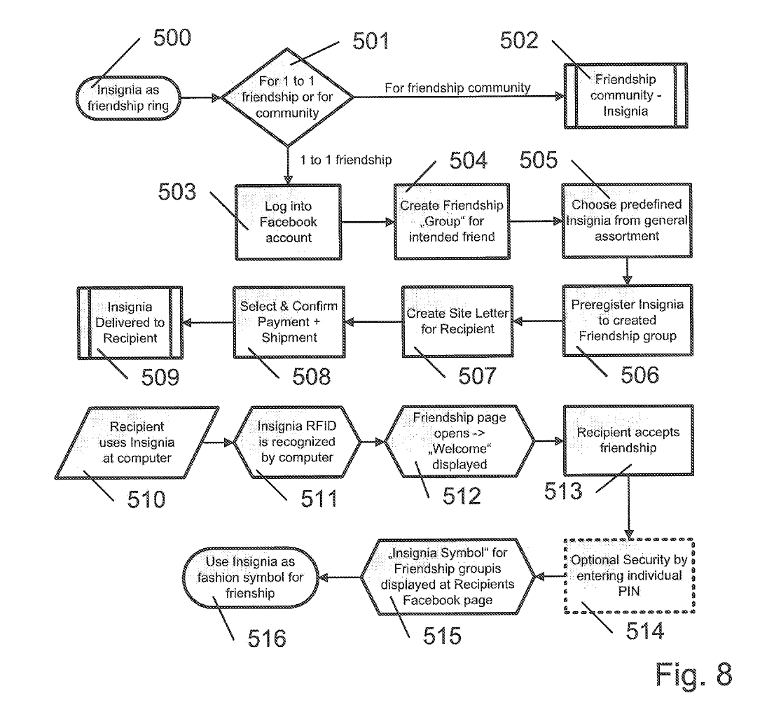

FIG. 8 shows the use of an insignia as a friendship object in a one to one environment;

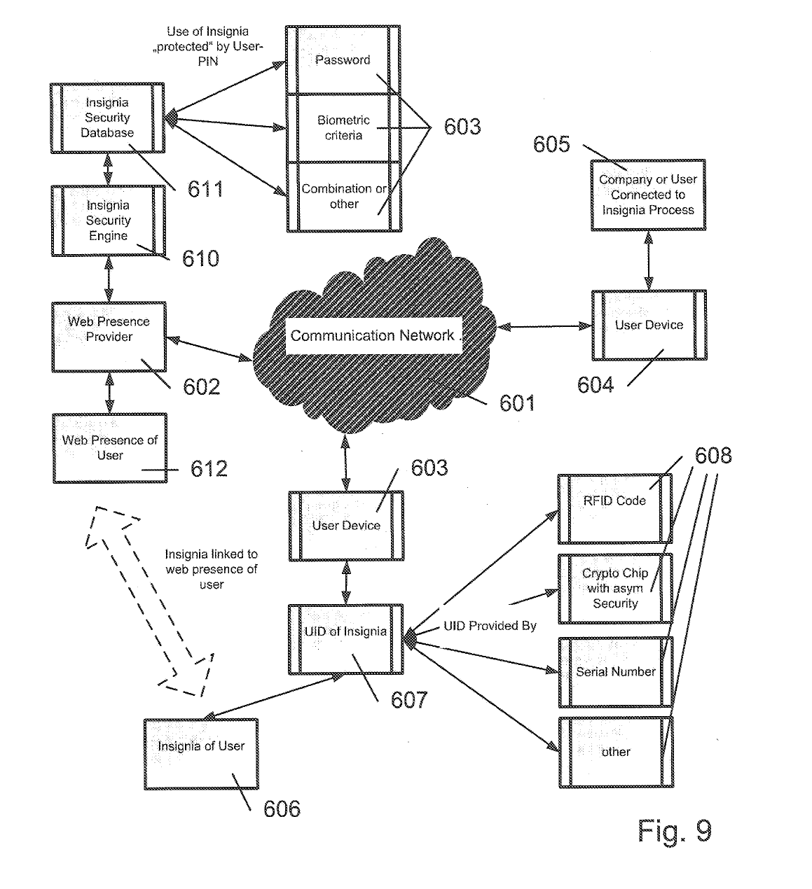

FIG. 9 illustrates a possible embodiment of a system comprising different components and objects for performing the present method;

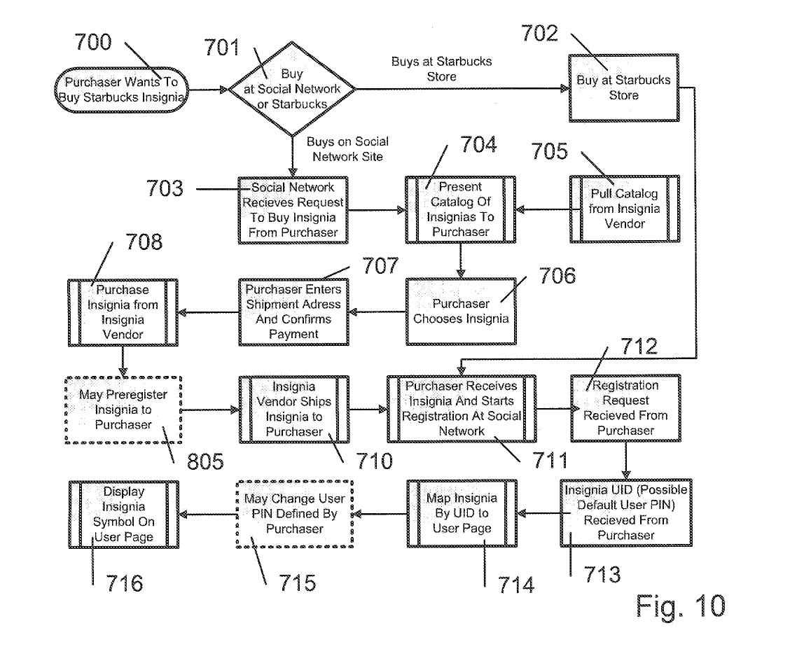

FIG. 10 illustrates the steps in purchasing an insignia from the viewpoint of a social network provider; and

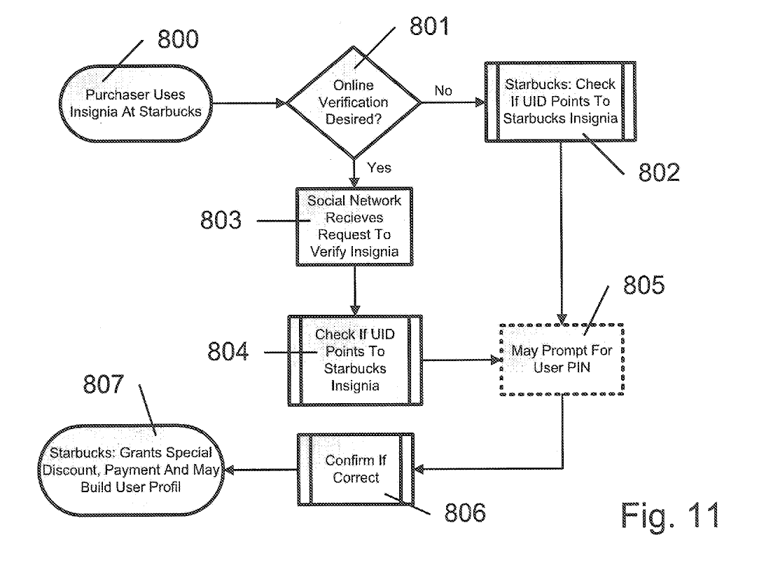

FIG. 11 shows the use of an insignia at a vendor site from the viewpoint of the vendor and the social network provider.

FIG. 1 to 4 show schematics of the arrangement of components of the insignia processes and their interactions for performing the method to link the owner of an insignia to a online user site or a group site according to different preferred embodiments.

The embodiment shown in FIG. 1 may be of use for a user attempting to access a vendor server 7 for ordering merchandize, which may include non-physical merchandize, while taking advantage of possessing an appropriate insignia 1. For this purpose, the insignia 1 with an identifier 2 attached thereto is placed in proximity to an input device 4 of a terminal 3, for example an RFID reader of a personal computer of the user. The input device reads in an identifier code from the identifier 2 and transmits the identifier code to the vendor server 7. This transmission is indicated in FIG. 1 by an arrow 11. Additionally to the identifier code, a personal identification number (PIN) may be read in from the identifier 2. In this case, the user may be prompted to enter a code, which is then compared to the PIN for added security.

The vendor server 7 in turn transmits 12 the identifier code to an insignia server 5, possibly together with a user name of the user or a group name. The insignia server 5 consults an insignia database 6 to verify whether the identifier code is included in it and/or if it is correlated to the user name or the group name transmitted along with the identifier code. As a result of this consultation, the insignia server 5 transmits 13 a verification result to the vendor server 7. If the verification has been successful, the vendor server 7 may resume communication with the terminal 3, which is indicated by the dashed arrow 14 in FIG. 1, for example an online shopping process.

A slightly different arrangement is illustrated in FIG. 2. Herein, the terminal is connected directly to the vendor server 7 and may be for example part of a cash register or a stand-alone user terminal in a store of the vendor. As opposed to the case described in connection with FIG. 1, there may be no communication necessary between the terminal 3 and the vendor server 7 after verification of the identifier code, because the selection and purchase of merchandize is performed by direct interaction between the user and a vendor or sales person.

In a different arrangement, the linkage of personalized insignia to user/group account of the online presence is implemented into the operating system of the user terminal 3. This can be done via a downloadable plug-in or a separated program to be installed. Once the insignia 1 is placed in proximity to the input device 4 connected to the terminal 3, the identifier 2 is recognized by the input device 4 and the identifier code read from it. Access to the identifier code can be limited or linked to a personal PIN to be entered by the user on the terminal 3. The identifier code of the insignia, and possible the PIN is then transmitted 11 to the server of the web presence provider 7. This server itself is forwarding the identifier code and if requested the PIN to the insignia server 5 for verification. The insignia server 5 consults its insignia database 6 to confirm that the insignia 1 has been registered before and that the personal PIN 2a is correct. If the insignia server 5 finds that the identifier code and optionally the PIN is correlated to a user account at the web presence provider, it send a confirmation with information of the user account to the server of the web presence provider 7. The web presence provider sends the confirmation back to the terminal 3, after which the installed plug-in or program allows the user to logon.

An additional process of the above activates a replication of the insignia credentials, as insignia identification code, user account information and possible personal PIN from the insignia server 5 to the plug-in or program installed on the user terminal 3 to create a mirror database 6′, as illustrated in FIG. 4. In doing so the terminal 3 caches the credentials, allowing the user to use the insignia 1 via identifier 2 and optional a personal PIN to log onto the terminal 3 itself, even if the connectivity 11 and 14 are not available.

Access can be limited to specific terminals 3, as the plug-in or program can define or read out additional identification codes of the terminal itself. If enabled, those terminal identification codes will be transmitted with the other credentials to the insignia server and will be verified against the insignia database. The corresponding acknowledgement will be send back via the web presence server 7 to the terminal, allowing local logon of the user.

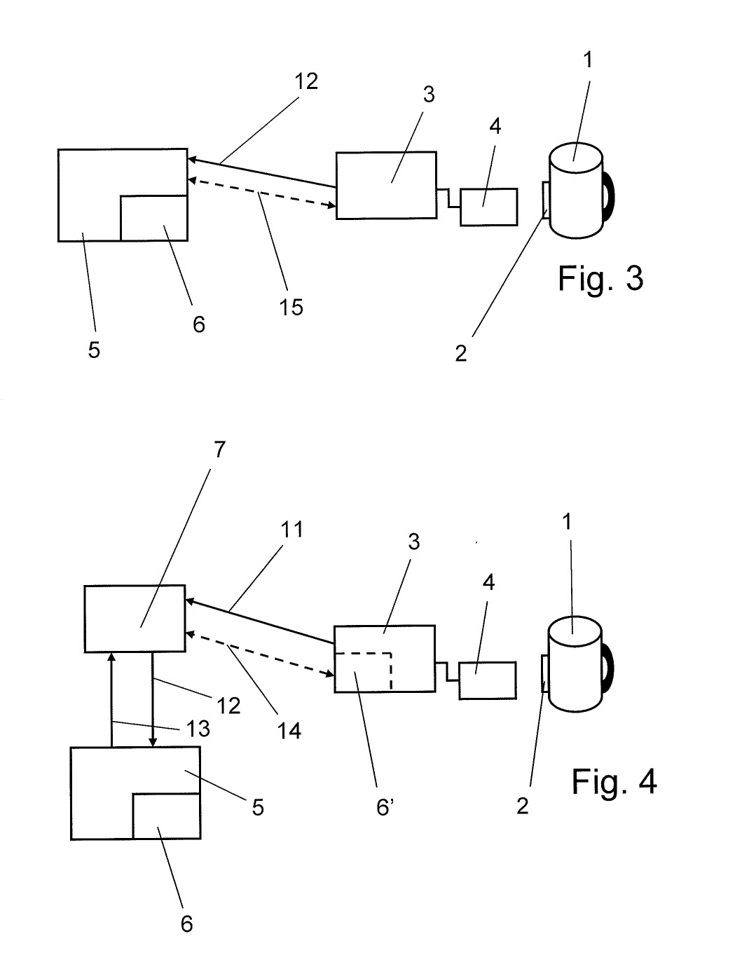

FIG. 3 depicts a situation, where the user terminal 3 communicates directly with the insignia server 5. In one embodiment, the user is already logged on to a social network provided by the network server 5. Once the insignia 1 is placed in proximity to the input device 4 connected to the terminal 3, the identifier 2 is recognized by the input device 4 and the identifier code read from it. The identifier code is then transmitted 12 to the network server 5 for verification. The network server 5 consults its insignia database 5 to confirm that the insignia 1 has been registered before. If the network server 5 finds that the identifier code is correlated to a group account on the social network, it may enable access of the user to the group site or to certain functions on the group site. Here, communication 15 between the terminal 3 and the network server 5 takes place continuously. Alternatively, it may depend upon a successful verification process that the communication 15 may take place.

One embodiment of the process of purchasing and utilizing the insignia 1 will be described in the following, with reference to FIG. 4. First, the insignia 1 is purchased from a vendor, for example in form of a reusable cup at a coffee shop. The buyer then attempts to register the purchased insignia 1 at the website of a social network. The insignia 1 is automatically recognized by a remotely functioning input device 4, namely an RFID reader, which reads out the identifier code from the identifier 2 attached to the insignia 1. As described above, the input device 4 may be connected to the personal computer at the user's home, or it may be connected to a cash terminal at a store, in particular at the coffee store the insignia 1 is bought at.

After the identifier code read in by the input device 4 is transmitted to the internet server of the social network 7 for the first time, the insignia may be mapped to a group corresponding to the vendor of the insignia 1, by entering the identifier code into the insignia database 6 of the insignia server 5 and correlating it to the corresponding group account. At the same time, the identifier code is preferably also correlated to the user account of the user and displayed at his/her user site, once he/she has logged onto his/her account. An optional security level might be added by also requesting the user to enter an individual insignia PIN code to be prompted when using the Insignia later on.

At some point during or after the registration process, information from the insignia database 6 may be sent to the terminal 3 to be cached or mirrored and thus to produce a mirrored database 6′. Any following verification steps may then utilize the mirrored database 6′ in place of the actual insignia database 6. This approach may have the advantage of faster verification. Furthermore, it may be used without communication 12, 15 taking place between the terminal 3 and the insignia server 5.

Once these steps of purchasing and registering the insignia have been successfully completed, the insignia may be used at the vendor that sold the insignia 1, or at any store of the vendor or any store connected to the vendor for this purpose. By using the insignia 1, the user may obtain special discount prices for merchandize or services. The user may choose merchandize and perform an authentication step at the cash desk of a vendor store by placing the insignia 1 near an RFID reader. Once the insignia 1 is recognized by the vendor server 7 through the validation process similar to the one described above in connection with FIG. 1, the cash register may automatically calculate an appropriate discount and subtract it from the final bill. While the user enjoys the merchandize, the vendor may use the information received from the user to build a user profile. It may also incorporate therein information obtainable from the user account at the social network, to which the vendor is also connected, and may even have a vendor account itself.

FIG. 5 is a flow diagram of a process for purchasing and offering an insignia as a present 200. While the captions and the diagram relate to the social network Facebook® and the non existent “ACME college”, the process may be used for any combination of online presence provider and online presence of a user, a group, a company or an organization with little or no adjustments. The described process shows procurement via the online presence provider. However, the insignia may also be chosen and bought onsite at a retail store or the organization here represented by “ACME college” itself. If bought onsite, the process may start at the following step 217.

In a first step 201, the user opens the web site of the social network. After logging in 202, he opens the group site of the desired “ACME college” 203. The web page is presenting its linked insignias and also a button to buy a new insignia 204. This may prompt the user to choose 205 between standard insignias offered by the social network provider, or individual ones. If no individual insignias exist or none are offered at the moment 208, the user may create individual ones for himself 209. This can be a very simple process of buying a separate identifier and attaching it to a physical object, up to a complex production, which incorporates a RFID chip into an object.

If individual insignias for the “ACME College” have been designed and are offered to the users, the assortment will be displayed to the user, in the same way the assortment of general insignias 206 are shown. The user chooses the preferred insignia from the list and is asked, if he wants to preregister the insignia to the corresponding group 207. Since the recipient of the insignia saves the registration process and a customized welcome page can be build by the presenter, a preregistration is especially beneficial, if the insignia will be given as a present. If the user decides to preregister the insignia to the web presence of “ACME group”, he checks the corresponding box, accepting the additional costs 210. During shipment, the standard process will be adjusted to prompt the responsible employees to “map” the insignia, which will be shipped, to the predefined web presence 211. The “mapping” process may be performed in various ways, for example by holding the insignia 1 next to an input device 4 of a terminal 3, which will read out the identifier code 2 and send this code to the prompting application to correlate it to the web presence at the insignia database 6, in a setup similar to the one shown in FIG. 3.

The user may create an accompanying letter for a presented insignia 213, if he wishes 212. Optionally he may also set up a welcome web page. After selecting and confirming shipment 214 and payment 215, the insignia is shipped and delivered 216. Depending on the shipment choice 218, the insignia reaches the user 217 or directly the recipient of the present 219. If the insignia is not preregistered 220, the recipient has to register it 221, otherwise the insignia is ready to be used.

The insignia may be used at the internet connected terminal 222 or onsite on the premises of “ACME College” 229. At the terminal, the recipient positions the insignia near a connected input device 223. The insignia identifier is recognized and read out by the terminal 224, and an online web page of “ACME College” or the created welcome page is displayed 225. If the recipient chooses to accept the membership 226, the corresponding insignia symbol is displayed next to his web presence on the social community 227, and he may be listed as owner of an “ACME College” insignia at the web presence of “ACME College”. Further on, the user may use the insignia to directly access the “ACME College” web presence 228. With additional security, such as a personal PIN, the insignia may also be used to access additional online services of ACME College 228.

At “ACME College”, the receiver of the insignia has then the opportunity to use the insignia for example to get access to the grounds of “ACME College” 230, to access events 231 and/or with additional security, such as a personal PIN, as identification 232. In addition to the above usages, the recipient may wear the insignia for fashion.

A flow chart illustrating a process wherein the insignia is purchased and used to log onto a computer 300 is depicted in FIG. 6. Similar to the case in FIG. 5, the user may choose 301 whether to buy the insignia at the web site hosting the online presence such as a social network 302, thus having to wait for the delivery of the insignia 304, or whether to directly purchase the insignia at a vendor store 303, such as a partner of the social network. Afterwards, the insignia will have to be registered at the provider of the online presence 305.

The registration process is similar to the one described in FIG. 5. Here, the web site of the online presence will be opened 306 and a logon procedure performed 307, to be able to access an insignia registration page 308. After placing the insignia in proximity to the input device of the terminal of the user 309, e.g. an RFID reader of a personal computer, the insignia is recognized automatically by the terminal 310, whereby an identification process starts 311. In the present embodiment, a default insignia password (PIN) will have to be entered 312, to initiate usage of the insignia. The insignia identifier code is than mapped to the personal online presence account of the user 313. Afterwards, the password should be changed from the default to a personally chosen PIN 314. Once the user has been identified the first time, a plug-in may be enabled 315 and then downloaded and installed at the operating system of the computer 316, thereby configuring the computer to initiate future logon procedures automatically upon recognition of the identifier of the insignia.

Thus, at a later time when the user starts using the computer 317, he or she will only have to start the computer 318, and place the insignia near the input device 319, where it is again recognized by the computer 320, starting the identification process automatically 321. Depending on the require level of the security the identification of the nearby insignia alone is sufficient to log on the user, or additionally the personal PIN has to be entered by the user 322. The verification of the user can be done against the online user account at the social network provider or the plug-in may cache a user profile to allow offline logon. The later is necessary, if the computer is not always online. After a successful verification the user is authenticated 323 and may use the computer 325. In addition and optionally, the PC may connect to the online presence via the internet and automatically log on to the user account of the user 324.

A process of purchasing and using the insignia 400 according to a different embodiment is described in connection to FIG. 7. After deciding 401 between buying the insignia directly at the social network 402 and waiting for the delivery 404, or purchasing the insignia directly at a vendor store 403, the user will again proceed to register the newly obtained insignia 405. For this purpose, the web site of the social network is opened 406 and the user logs onto his or her user account 407. There, a special insignia page may be opened 408 for first time registration.

The user then places the insignia in proximity to the input device of a personal computer or another appropriate terminal 409, whereupon the insignia is recognized 410 and an identification process begins 411. This process comprises entering a default PIN of the insignia 412, mapping the insignia to a vendor group at the social network 413 and then changing the PIN to a personal PIN 414. Note that the mapping described above comprises for the insignia server to enter the identification code of the identifier attached to the insignia into the insignia database and to correlate it to the group account of the vendor group there. Afterwards, an icon representing the insignia may be displayed on the personal user site of the user whenever the user or others view the user site on the social network 415.

After registration at the social network, the insignia may be used at a store of the vendor 416. There, the user may order merchandise 417 and move to the cash desk to pay. By placing the insignia near an input device of the cash desk 418, an identification process begins 419, wherein the identifier of the insignia is recognized by the cash desk 420, which acts as a terminal in the present sense, sending the identifier code read in from the identifier to the insignia server of the social network for verification. When the verification has been successful, as described above, the user may obtain certain benefits 421, such as a discount on the merchandize he or she is about to purchase. While the user enjoys the purchased merchandize 422, the vendor has the option of building a user profile 423 using information about the user obtained through the communication with the internet server.

FIG. 8 illustrates an embodiment of a process of using an insignia with an identifier as a friendship ring 500, for symbolizing a connection or commitment between two or more people. The friendship ring insignia may be in the shape of an actual ring to be worn, or it may have any other shape or form suitable for indicating a friendship between two or more people, for example clothing or other accessories. The choice between an insignia for a one to one friendship and a community insignia for more than two friends is indicated as a first step 501 in FIG. 8. If the insignia is intended for a friendship community 502, a slightly different process will be followed, as described later on.

In case of a one to one friendship, an initiating user may log onto a social network site 503 and create a group account on that site 504. Then he or she will have to choose one of a given number of preconfigured insignia 505 and preregister the insignia 506. The preregistration may comprise recording the insignia and correlating it to the group account in an insignia database of the social network. Then the user may create a message or build “welcome web page” to a chosen recipient 507 and fulfill any payment requirements 508 to ensure the delivery of the insignia to the chosen recipient 509.

The recipient, after receiving the insignia, can now use the insignia at his or her own personal computer 510. When bringing the insignia into proximity of the input device of the recipient's PC, the identifier attached to the insignia will be recognized by the input device 511, leading to a welcome page on the social network website to be opened and displayed automatically 512. On the welcome page, the recipient may be prompted to accept the friendship offer by the user who gave the insignia to the recipient 513. Afterwards, there is an optional step of prompting the recipient to enable added security by activating, defining and later on using individual password (PIN) 514. Once the friendship offer has been accepted, an icon representing the insignia may be displayed at a user site of the recipient on the social network 515. Consecutively, the recipient may carry or wear the friendship insignia as a fashion symbol for friendship 516.

Alternatively to a one to one (1:1) friendship, a friendship community may be started or a 1:1 friendship may be expanded into such a friendship community. The process of a friendship community is very similar to the above, but instead of stopping with one friend, the initiator or the recipient of the friendship insignia may furthermore give the friendship insignia to a third person and to as many as they like. Depending on the setup, the original friendship insignia may be worn for a time by the recipient, before presenting it to another friend, thus imprinting the friendship onto the friendship insignia. Or each member of the friendship community may order additional friendship insignias to present to new friends. After giving the friendship insignia to a new friend, the presenter may order a replica friendship insignia to worn by them self.

An embodiment of a system comprising physical and/or virtual components and objects is illustrated with the schematic diagram in FIG. 9. Here, it is assumed that a communication network 601 is provided for connecting the different servers and terminals of the system. In particular, the internet may be such a communication network 601. An online presence provider 602 may be accessed through the communication network 601 by a multitude of user devices 603, 604. These user devices 603, 604 are terminals in the present sense. In particular, they might be personal computers of the users. Or they might be connected to a company server 605.

As indicated in FIG. 9, the user may have a user account with a web page 612 provided by the online presence provider 602. Furthermore, the user owns an insignia 606, which is virtually connected to the user account 612. This connection is indicated by the dashed arrow 613 and may be implemented through the correlation in the insignia database described above. Furthermore, an additional level of security for the use of the insignia may be implemented via a security engine 610 accessing an insignia security database 611, which may store insignia information together with different profiles of the security measures 609. These security measures 609 may comprise one or a combination of a password, biometric data, or the like.

As described above, each insignia 606 has a unique identifier code 607, which may be implemented by a variety of identifiers 608 attached to the insignia 606. These identifiers 608 include an RFID chip, a crypto chip or cryptoprocessor, advantageously with asymmetric security, or a simple tab with a serial number printed on it.

The process steps that take place when a user attempts to purchase an insignia 700 is shown by the diagram of FIG. 10 from a viewpoint of the social network. Here, the first steps depend on whether the user chooses 701 to buy the insignia at a vendor store 702, in which case the user receives the insignia right away. In the case the user chooses to purchase the insignia via the social network website, the web server of the social network provider may receive a corresponding request from the personal computer's web browser of the user 703.

The web server then presents a catalog of available insignia to the user 704, possibly after downloading the catalog from a web server of the vendor offering the insignia 705. After the user chooses the insignia from among the available options and models 706, the web server prompts for a shipment address and other necessary information as well as for a confirmation of the purchase 707. Then the social network provider will purchase the insignia for the user directly from the vendor 708 and instruct the vendor to deliver the insignia to the user 709. Optionally, the insignia may be preregistered to the recipient by the social network provider before or parallel to the shipment 709.

After receiving the insignia, the user starts to register it at the social network provider 711. The corresponding web server receives the registration request 712 and prompts the user for an identifier code of the insignia 713, and if enabled for a default PIN, which may be changed by the user later on 715. The step of submitting the identifier code may preferably be performed automatically by an input device remotely, electronically or optically, e.g. via an RFID reader. The insignia is then mapped to the web presence and/or user account of the user 714, by correlating the identifier code to the user account in the insignia database. Finally, the ownership of the insignia may be indicated by displaying an appropriate icon on the user site of the user 716.

Finally, FIG. 11 shows the steps being performed from the viewpoint of the vendor sever and the social network provider, when the user uses the purchased insignia at a vendor store 800, after the identifier code of the insignia has been read in by the input device. First, it has to be decided by the vendor and/or the social network provider, whether an online verification is desired 801. If this is not the case, the vendor server may verify that the identifier code refers to a pool of insignia codes associated with the vendor itself 802, for example by comparing parts or all of the identifier code to a reference code. Optionally, the user may be prompted for a user PIN 805.

For an online verification, the social network provider is requested by the vendor server to verify the identifier code 803. The social network provider then tests whether the identifier code submitted to it is correlated to a vendor account of the vendor in the insignia database of the social network 804, in which case the insignia is considered to point to the vendor. As in the alternative case, the user may optionally be prompted for a PIN to allow usage of the insignia 805, which is verified 806. As a result, the vendor server may grant a discount to the user when ordering merchandize 807.

FIGS. 10 and 11 apply similarly to cases where the insignia is to be linked to a group account on the social network other than a vendor group account. An example for such a group account may be a college group or any other suitable group. In this case, the function of the vendor server in FIGS. 10 and 11 is taken over by a college server.

1. Method for creating a personalized insignia by linking a physical object to an online presence of a user or a group through an identifier (2) attached to the insignia (1) comprising the physical object, whereby the method comprises the following steps:
Reading in of an identifier code, which is carried by the identifier (2) and is unique to the insignia (1), to which the identifier (2) is attached, at an input device (4) of a terminal (3) located in a proximity of the insignia (1);
Receiving the identifier code from the terminal (3) by an insignia server (5) operated by an insignia provider;
Searching through an insignia database (6) of the insignia server (5) correlating identifier codes to user accounts and/or group accounts;
Verifying that the identifier code is correlated to a certain user account and/or a certain group account of the online presence.

2. Method according to claim 1, characterized by that the identifier code is carried by the identifier (2) electronically.

3. Method according to claim 1, characterized by that the identifier code is read in from the identifier by the input device (4) automatically.

4. Method according to claim 3, characterized by that the identifier code is read in from the identifier (2) by the input device (4) remotely.

5. Method according to claim 1, characterized by that the online presence is part of a social network.

6. Method according to claim 1, characterized further by the following steps:
Sending the identifier code read in at the input device (4) by the terminal (3) to a vendor server (7);
Sending the identifier code received by the vendor server (7) to the insignia server (5);
Receiving a verification message (13) from the insignia server (5) by the vendor server (7), whereby the verification message (13) comprises user account information and/or group account information identifying the certain user account and/or the certain group account of the online presence, to which the identifier code is correlated.

7. Method according to claim 1, characterized further by the following steps:
Sending the identifier code read in at the input device by the terminal (3) to a vendor server (7);
Sending the identifier code received by the vendor server (7) to the insignia server (5) together with a user name corresponding to the user account and/or a group name corresponding to the group account; and
Receiving a verification message (13) from the insignia server (5) by the vendor server (7), whereby the verification message (13) confirms that the identifier code is correlated to the user account and/or the group account of the online presence.

8. Method according to claim 1, characterized further by the following steps:
Sending the identifier code read in at the input device (4) by the terminal (3) to the insignia server (5); and
Enabling access to the user account and/or the group account by the terminal (3), if during the verifying step it is determined that the identifier code is correlated to that user account and/or that group account of the online presence.

9. Method according to claim 8, characterized by that enabling access to the user account and/or the group account comprises a login procedure, whereby a user at the terminal (3) logs into a user site or into a group site.

10. Method according to claim 1, characterized by a step of mirroring entries of the insignia database (6) onto the terminal (3) to produce a mirror database (6′) for reference in cases a connection to the insignia server (5) cannot or should not be established.

11. Method according to claim 1, characterized by a step of receiving a personal identification number (PIN) by the insignia server (5) and a step of verifying that the personal PIN is associated to the identifier code in the insignia database (6).

12. Method according to claim 11, characterized by a step of sending the PIN requested by the terminal (3) and entered by the user to a vendor server (7).

13. Method according to claim 1, characterized by a step of registering the insignia (1) with the online presence, wherein the identification code is received by the insignia server (5) and inserted into the insignia database (6), correlating it to the user account and/or the group account.

14. Method according to claim 13, characterized by that during the step of registering the insignia (1), the identification code is inserted electronically into the identifier (2) of the insignia (1).

15. Method according to claim 1, characterized by a step of displaying the correlation between the insignia (1) and the user account and/or the group account at a corresponding user site or a corresponding group site in the online presence.

16. Method for creating a personalized insignia by linking a physical object to an online presence of a user or a group through an identifier (2) attached to the insignia (1) comprising the physical object, whereby the method comprises the following steps:
Receiving an order for the insignia (1);
Registering the insignia (1) with the online presence, wherein the identification code is generated or received by the insignia server (5) and inserted into the insignia database (6), correlating it to the user account and/or the group account;
Inserting the identification code into the identifier (2) of the insignia (1); and
Sending the insignia (1) to a vendor or to a user.

17. Method according to claim 16, characterized by a step of building a user profile based on online and/or offline activities of the user of the personalized insignia (1), whereby for building the user profile, an analysis is performed, taking into account the usage of the insignia (1) in correlation to the identifier (2), access and verification requests directed at the insignia database (6), and/or access to a terminal of a partnering company.

18. Personalized insignia (1) comprising a physical object and an identifier (2) attached to the physical object, whereby the identifier (2) comprises an identifier code, which is unique to the insignia (1) and is included in an insignia database (6) mapped to an online presence directly or via an insignia server (5), correlating the identifier code to a certain user account and/or to a certain group account of the online presence.
